(19) United States
(12) Patent Application Publication
(10) Pub. No.: US 2018/0262499 A1
(43) Pub. Date: Sep. 13, 2018

(54) METHOD AND SERVER FOR IMPLEMENTING CONTROL OF SMART DEVICES BY MASTER DEVICES

(71) Applicants: BEIJING QIHOO TECHNOLOGY COMPANY LIMITED, BEIJING (CN); QIZHI SOFTWARE (BEIJING) COMPANY LIMITED, BEIJING (CN)

(72) Inventors: HUIZHONG TANG, BEIJING (CN); JINAN SHI, BEIJING (CN)

(73) Assignees: BEIJING QIHOO TECHOLOGY COMPANY LIMITED, BEIJING (CN); QIZHI SOFTWARE (BEIJING) COMPANY LIMITED, BEIJING (CN)

(21) Appl. No.: 15/740,547

(22) PCT Filed: Jun. 12, 2016
(86) PCT No.: PCT/CN2016/085431

§ 371 Date: Dec. 28, 2017

(30) Foreign Application Priority Data
Dec. 3, 2015 (CN) 201510884946.3

(51) Int. Cl. H04L 29/06; H04L 29/08

(52) U.S. Cl. CPC H04L 63/0876; H04L 67/025

(57) ABSTRACT

The present disclosure provides a method and a server for implementing control of smart devices by master devices. The method comprises, for a smart device: according to the device identifier of the smart device, obtaining the device identifier of the master device corresponding to the smart device from the control relation database, and obtaining the device identifier of the smart device from a first association database; establishing the association relations between the master devices corresponding to the associated smart devices and the master device corresponding to the smart device.

### CROSS REFERENCE TO RELATED APPLICATIONS

This application is national stage application of PCT/CN2016/085431 filed Jun. 12, 2016, and is based upon and claims priority to Chinese Patent Application No. 201510884946.3, filed in China on Dec. 3, 2015, the entire contents of which are incorporated herein by reference.

### TECHNICAL FIELD

The present disclosure relates to the field of Internet technology, and specifically to a method and a server for implementing control of smart devices by master devices.

### BACKGROUND

With the rapid development of mobile Internet, a wide variety of smart devices have appeared one after the other, and with the continual simplification of human-computer interaction of the smart devices, the range of applicable people for the smart devices is also continually expanding, and the smart devices applicable for the groups needed to be paid attention to, such as the elderly, children, the sick, etc., also appear in people's field of vision. With the portable features and intelligent communication features of the smart devices, users of the smart devices can be paid attention to and managed more conveniently and timely.

However, in the prior art, for a users who has requirements for management and control, a scheme for management and control of the smart device of the user usually is: associating the smart device of the user with a master device one-to-one and obtaining, by the master device, status of the user through communication with the smart device of the user. For example, in the event that a child is wearing a smart watch, the phone number of the parent will be stored in the smart watch of the child, and the parent is made to know about the child through the communication (making a phone call or sending messages) between the smart watch of the child and the mobile phone of the parent. It is easy to know that, in this scheme, relevant information on the corresponding smart device obtained by the master device is actually informed of by the user of the smart device on his/her own initiative, that is, the information obtained by the master device can only be referenced exparte and finitely.

### SUMMARY

In view of the above problem, the present disclosure is proposed to provide a method and a server for implementing control of smart devices by master devices for overcoming or at least partly solving the above problem.

In accordance with an aspect of the present disclosure, a method for implementing control of smart devices by master devices is provided. The method comprises:

receiving control authority authentication information on a corresponding smart device transmitted by a master device and after successfully authentication, storing correspondingly a device identifier of the master device and a device identifier of the corresponding smart device into a control relation database;

for a smart device:

according to device identifier of the smart device, obtaining device identifier of the master device corresponding to the smart device from the control relation database, and obtaining first association information of the smart device from a first association database, the first association information including a device identifier of an associated smart device;

according to the device identifier of each associated smart device, obtaining the device identifier of the master device corresponding to the associated smart device from the control relation database; storing correspondingly the device identifier of the master device corresponding to the associated smart device and the device identifier of the master device corresponding to the smart device into a second association database, and establishing an association relation between the master device corresponding to the associated smart device and the master device corresponding to the smart device.

In accordance with another aspect of the present disclosure, a server for implementing control of smart devices by master devices is provided. The server comprises: one or more processors; and a memory; wherein one or more programs are stored in the memory, and when executed by the one or more processors, the one or more programs cause the server to: receive control authority authentication information on a corresponding smart device transmitted by a master device and after successfully authentication, store correspondingly a device identifier of the master device and a device identifier of the corresponding smart device into a control relation database; for a smart device: according to device identifier of the smart device, obtain the device identifier of the master device corresponding to the smart device from the control relation database, and obtain first association information of the smart device from a first association database, the first association information including a device identifier of an associated smart device; according to the device identifier of each associated smart device, obtain the device identifier of the master device corresponding to the associated smart device from the control relation database; store correspondingly the device identifier of the master device corresponding to the associated smart device and the device identifier of the master device corresponding to the smart device into a second association database, and establish an association relation between the master device corresponding to the associated smart device and the master device corresponding to the smart device.

In accordance with an aspect of the present disclosure, a computer program is provided, comprising a computer readable code, which, when the computer readable code is running on a server, causes the server execute the above described method for implementing control of the smart devices by the master devices.

In accordance with another aspect of the present disclosure, a computer readable medium is further provided, in which the above described computer program is stored.

As can be known from the above that, in the technical solution provided by the present disclosure, on the one hand corresponding control relations between the master devices and the smart devices are obtained and stored through authentication and on the other hand association relations between the smart devices are stored, and in accordance with the association relation between the smart device and the smart device, an association relation between the corresponding master devices is established. In accordance with this solution, association information between the master devices is passively established on the basis of the association information between the smart devices, such that the control of the smart devices by the master devices is no longer limited to a one-on-one individual control, but rather the master devices monitor and control the association information between the corresponding smart devices by means of the association information between the master devices, and a more comprehensive and effective control of the corresponding smart devices by the master devices is achieved.

The above explanation is merely an overview of the technical solutions of the present disclosure. In order to be able to understand more clearly and embody the technical means of the present disclosure in accordance with the contents of the description, and in order to make the above and other objectives, features and advantages of the present disclosure more obvious and understandable, specific embodiments of the present disclosure are described below.

### BRIEF DESCRIPTION OF THE DRAWINGS

By reading the detailed description of the preferred embodiments below, various other advantages and benefits will become clear for a person of ordinary skill in the art. The drawings are only used for the purpose of showing of the preferred embodiments and are not intended to limit the present disclosure. And in the whole drawings, same drawing reference signs are used for representing same components. In the drawings:

FIG. 1 shows a flow chart of a method for implementing control of smart devices by master devices according to an embodiment of the present disclosure;

FIG. 2 shows a schematic diagram of a server for implementing control of smart devices by master devices according to an embodiment of the present disclosure;

FIG. 3 schematically shows a block diagram of a server for executing the method according to the present disclosure; and

FIG. 4 schematically shows a storage unit for holding or carrying a program code for implementing the method according to the present disclosure.

### DETAILED DESCRIPTION

Hereinafter, exemplary embodiments of the present disclosure will be described in more detail with reference to the accompanying drawings. Although the exemplary embodiments of the present disclosure are shown in the accompanying drawings, it should be understood that the disclosure may be implemented in various forms and should not be limited to the embodiments set forth herein. Rather, these embodiments are provided so that this disclosure can be more thoroughly understood and the scope of the disclosure can be fully conveyed to those skilled in the art.

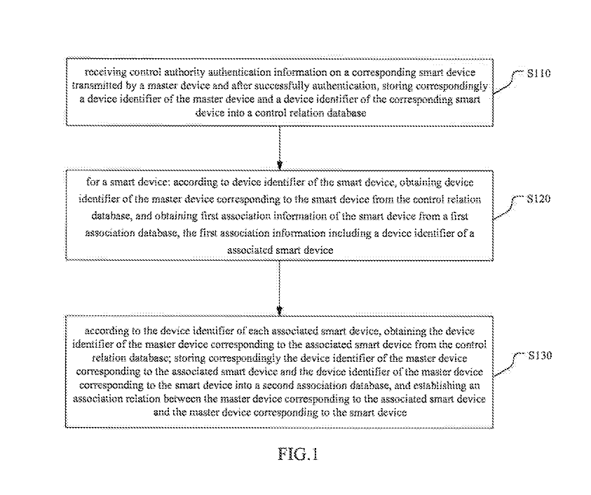

FIG. 1 shows a flow chart of a method for implementing control of smart devices by master devices according to an embodiment of the present disclosure. As shown in FIG. 1, the method comprises:

a step S110 of receiving control authority authentication information on a corresponding smart device transmitted by a master device and after successfully authentication, storing a correspondingly device identifier of the master device and the device identifier of the master device corresponding to the smart device into a control relation database.

a step S120 of, for a smart device, according to the device identifier of the smart device, obtaining the device identifier of the master device corresponding to the smart device from the control relation database, and obtaining first association information of the smart device from a first association database, the first association information including a device identifier of an associated smart device.

a step S130 of, according to the device identifier of each associated smart device, obtaining the device identifier of the master device corresponding to the associated smart device from the control relation database; storing correspondingly the device identifier of the master device corresponding to the associated smart device and the device identifier of the master device corresponding to the smart device into a second association database, and establishing an association relation between the master device corresponding to the associated smart device and the master device corresponding to the smart device.

As can be seen that, in the method shown in FIG. 1, on the one hand corresponding control relations between the master devices and the smart devices are obtained and stored through authentication and on the other hand association relations between the smart devices are stored, and in accordance with the association relation between the smart device and the smart device, an association relation between the corresponding master devices will be established. For example, if smart devices associated with a smart device a include a smart device b, a smart device c and a smart device d, then association information of the master device A of the smart device a will be established so that master devices associated with the master device A include the master device B of the smart device b, the master device C of the smart device c and the master device D of the smart device d. In accordance with this solution, the association information between the master devices is passively established on the basis of the association information between the smart devices, such that the control of the smart devices by the master devices is no longer limited to a one-on-one individual control, but rather the master devices monitor and control the association information between the corresponding smart devices by means of the association information between the master devices, and a more comprehensive and effective control of the corresponding smart devices by the master devices is achieved.

In an embodiment of the present disclosure, the first association database includes a first friend list database in which friend relation between the smart devices is stored; the first association information of the smart device includes pieces of friend information in the friend list of the smart device; the device identifier of the each associated smart device includes the device identifier of the smart device of a friend corresponding to each piece of friend information. And the second association database includes a second friend list database in which friend relation between the master devices is stored. Then, the establishing the association relations between the master devices corresponding to the associated smart devices and the master device corresponding to the smart device in the step S130 includes: establishing friend relation between the master device corresponding to the smart device of the friend and the master device corresponding to the smart device.

For example, corresponding control relations between respective master device and respective smart device have already been stored in the control relation database and for a smart device a: according to the device identifier “a” of the smart device a, the device identifier “A” of the master device A corresponding to the smart device a will be obtained from the control relation database, and the friend list of the smart device a will be obtained from the first friend list database, as shown in Table 1:

TABLE 1

| Friend | Smart device | Device identifier |
|---|---|---|
| Friend 1 | Smart device b | b |
| Friend 2 | Smart device c | c |

As can be seen from the Table 1 that, two pieces of friend information are included in the friend list of the smart device a and each piece of friend information includes the device identifier of the smart device of the friend.

According to the device identifier “b”, the device identifier “B” of the master device B corresponding to the smart device b will be obtained from the control relation database, the device identifier “B” and the device identifier “A” will be correspondingly stored into the second friend list database, and the friend relation between the master device B of the smart device b and the master device A of the smart device a will be established. Similarly, according to the device identifier “c”, the device identifier “C” of the master device C corresponding to the smart device c will be obtained from the control relation database, the device identifier “C” and the device identifier “A” will be correspondingly stored into the second friend list database, and the friend relation between the master device C of the smart device c and the master device A of the smart device a will be established. Thus, the friend list of the master device A established in the second friend list database is as shown in Table 2:

TABLE 2

| Friend | Smart device | Device identifier |
|---|---|---|
| Master of Friend 1 | Master device B corresponding | B |
| | to Smart device b | |
| Master of Friend 2 | Master device C corresponding | C |
| | to Smart device c | |

That is, in the present example, the association information of the master device A corresponding to the smart device a is established in accordance with the association information of the smart device a.

In an embodiment of the present disclosure, the above establishing the friend relation between the master device corresponding to the smart device of the friend and the master device corresponding to the smart device includes: according to the device identifier of the master device corresponding to the smart device, obtaining user contact information of the master device from a contact information database and obtaining the friend list of the master device from the second friend list database; according to each device identifier in the friend list, obtaining the user contact information corresponding to the device identifier from the contact information database; transmitting the user contact information of the master device corresponding to the smart device to the master device corresponding to the device identifier and transmitting the user contact information of the master device corresponding to the device identifier to the master device corresponding to the smart device; wherein the user contact information of each master device includes contact information of the user of the master device and contact information of the users of the smart devices having control relation with the master device.

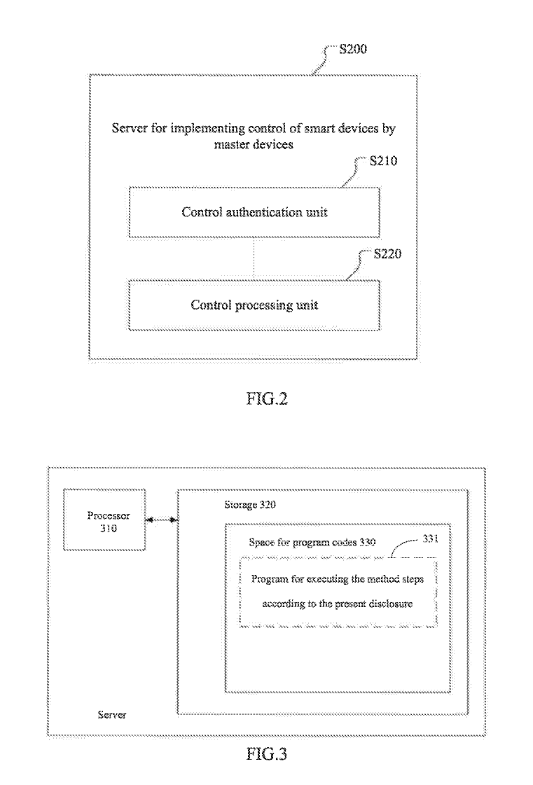

Continue with the example above, in the process of establishing the friend relation of the master device A corresponding to the smart device a in accordance with the friend relation of the smart device a, according to the device identifier “A” of the master device A, the user contact information of the master device A will be obtained from the contact information database, the friend list of the master device A as shown in FIG. 2 will be obtained from the second friend list database, the user contact information of the master device B and the user contact information of the master device C will be obtained from the contact information database, respectively, the user contact information of the master device A will be transmitted to the master device B and the master device C, and the user contact information of the master device B and the user contact information of the master device C will be transmitted to the master device A, so that the master device A and any master device in the friend list thereof can be informed of each other's user contact information and the user contact information of the smart device controlled by the other party and thus communicate with each other.

Further, in an embodiment of the present disclosure, the method shown in FIG. 1 may further comprise a step S140, which comprises the following steps:

a step S141 of receiving a communication request message sent by a smart device, communication data, the device identifier of the smart device and the device identifier of the smart device of a specified friend being included in the communication request message.

a step S142 of, according to the device identifier of the smart device, obtaining the device identifier of the master device corresponding to the smart device from the control relation database; according to the device identifier of the smart device of the specified friend, obtaining the device identifier of the master device corresponding to the smart device of the specified friend from the control relation database.

a step S143 of, according the obtained device identifier, transmitting the communication request message to the smart device of the specified friend, the master device corresponding to the smart device and the master device corresponding to the smart device of the specified friend respectively.

Continue with the example above, the smart device a transmits a communication request message of a specified smart device b and then the communication request message will be transmitted to the smart device b, the master device A of the smart device a and the master device B of the smart device b, respectively, so that the master devices can be informed of the communication data received or transmitted by the smart devices controlled by the master devices and grasp information dynamics of the smart devices. That is, the communication data between the smart devices will be pushed into the corresponding master devices.

Further, in an embodiment of the present disclosure, the method shown in FIG. 1 may also comprise a step S150, which comprises the following steps:

a step S151 of receiving a communication request message sent by a master device, communication data, the device identifier of the master device and the device identifier of the master device specified in a friend list being included in the communication request message.

a step S152 of, according to the device identifier of the specified master device, transmitting the communication data and the device identifier of the master device to the specified master device.

Continue with the example above, the master device A transmits a communication request message of a specified master device B and the communication data in the communication request message is transmitted to the master device B. That is, the communication data between the master devices will not be pushed to the corresponding smart devices.

Further, in an embodiment of the present disclosure, the method shown in FIG. 1 may further comprise:

a step S160 of, when device identifiers of multiple smart devices are bounded to each other, establishing a smart device group, wherein there is a friend relation between any two smart devices in a relation of the group. According to the device identifier of each smart device, the device identifier of the master device corresponding to the smart device is obtained from the control relation database. And the device identifiers of the multiple master devices corresponding to the multiple smart devices are bounded to each other and a master device group corresponding to the smart device group will be established.

When any smart device in the smart device group wishes to transmit communication data in the smart device group, a communication request message transmitted into the smart device group by any smart device in the smart device group is received, the communication data and the device identifier of the smart device the communication data being included in the communication request message; then the communication request message is transmitted to other respective smart devices in the smart device group, and the communication request message is transmitted to respective master devices in the master device group corresponding to the smart device group.

When any master device in the master device group wishes to transmit communication data in the master device group, a communication request message transmitted into the master device group by any master device in the master device group is received, the communication data and the device identifier of the master device being included in the communication request message; and the communication request message is transmitted to respective master devices in the master device group.

Continue with the above example, when the smart device a, the smart device b and smart device c are bounded to each other to establish a smart device group {a,b,c}, the master device A, the master device B and the master device C are also bounded to each other to establish a master device group {A,B,C} corresponding to the master device group {a,b,c}. When the smart device a transmits a communication request message to the smart device group {a,b,c}, the communication data in the communication request message will be transmitted to the smart device b and the smart device c, and the communication data in the communication request message will be transmitted to the master device A, the master device B and the master device C, so that the respective master devices in the master device group {A,B,C} will be informed of the communication data transmitted in the smart device group {a,b,c}. When the master device A transmits a communication request message to the master device group {A,B,C}, the communication data in the communication request message will only transmitted to the master device B and the master device C.

The implementation of the present solution will be explained with a specific embodiment. In the present embodiment, the above smart devices a, b and c are respectively smart watches worn each by three children a, b and c. The child a adds the smart watch b of the child b and the smart watch c of the child c as friends on the smart watch a. The master devices A, B and C of the above smart devices are respectively the respective mobile phones of the parents A, B and C of the three children a, b and c. According to the friend relation of the child a on the smart watch a, the friend relation of the mobile phone A of the parent A with the mobile phone B of the parent B and the mobile phone C of the parent C will be established and the contact information of the parent A will be transmitted to the mobile phone B of the parent B and the mobile phone C of the parent C while the mobile phone A of the parent A will also obtain the contact information of the parent B and the parent C. The name of the parent, the name of the child of the parent, the phone number of the parent, etc. are included in the contact information of each parent, so that the respective parents can directly communicate with each other and each parent can obtain comments on his own child by other children from other parents and know about the child from others. Further, conversation information of the specified friend b/c transmitted by the child a and conversation information of the specified child a transmitted by the friend b/c of the child a will also be pushed to the mobile phone A of the parent A and the mobile phone B/C of the parent B/C, so that the parents can be informed of the conversation information between the children and thus informed of interaction dynamics between the children. And when the three smart watches a, b, c are bounded to each other at a server to establish a group, the members of which are the three children a, b, c, the mobile phones A, B, C will be bounded to each other at the server to establish a group, the members of which are the parents A, B, C, speech of any child in the group will be pushed to the mobile phones of the three parents, which helps to know about the actual situations of the children. In this process, in order that the interaction between the children is not influenced, any information of the parents will not be pushed to the smart watches of the corresponding children. It should be noted that, selection of the smart device and the master device in the present embodiment is not limited to the present solution and a suitable smart terminal can be selected as the smart device or the master device according to the actual situation.

FIG. 2 shows a schematic diagram of a server for implementing control of smart devices by master devices according to an embodiment of the present disclosure. As shown in FIG. 2, the server 200 for implementing the control of the smart device by the master device comprises:

a control authentication unit 210 configured to receive control authority authentication information on a corresponding smart device transmitted by a master device and after successfully authentication, store correspondingly a device identifier of the master device and a device identifier of the corresponding smart device into a control relation database.

a control processing unit 220 configured to, for a smart device: according to device identifier of the smart device, obtain device identifier of the master device corresponding to the smart device from the control relation database, and obtain first association information of the smart device from a first association database, the first association information including a device identifier of an associated smart devices; according to the device identifier of each associated smart device, obtain the device identifier of the master device corresponding to the associated smart device from the control relation database; store correspondingly the device identifier of the master device corresponding to the associated smart device and the device identifier of the master device corresponding to the smart device into a second association database, and establish an association relation between the master device corresponding to the associated smart device and the master device corresponding to the smart device.

As can be seen that, the server shown in FIG. 2 on the one hand obtains and stores corresponding control relations between the master devices and the smart devices through authentication and on the other hand stores association relations between smart devices, and in accordance with the association relation between the smart device and the smart device, establishes an association relation between the corresponding master devices. In accordance with this solution, the association information between the master devices is passively established on the basis of the association information between the smart devices, such that the control of the smart devices by the master devices is no longer limited to a one-on-one individual control, but rather the master devices monitor and control the association information between the corresponding smart devices by means of the association information between the master devices, and a more comprehensive and effective control of the corresponding smart devices by the master devices is achieved.

In an embodiment of the present disclosure, the first association database includes a first friend list database in which friend relation between the smart devices is stored; the first association information of the smart device includes pieces of friend information in the friend list of the smart device; the device identifier of the each associated smart device includes the device identifier of the smart device of a friend corresponding to each piece of friend information; the second association database includes a second friend list database in which friend relation between the master devices is stored; and then the control processing unit 220 in the server shown in FIG. 2 is configured to establish friend relation between the master device corresponding to the smart device of the friend and the master device corresponding to the smart device.

In an embodiment of the present disclosure, the control processing unit 220 in the server 200 shown in FIG. 2 is configured to, according to the device identifier of the master device corresponding to the smart device, obtain user contact information of the master device from a contact information database and obtain the friend list of the master device from the second friend list database; according to each device identifier in the friend list, obtain the user contact information corresponding to the device identifier from the contact information database; transmit the user contact information of the master device corresponding to smart device to the master device corresponding to the device identifier and transmit the user contact information corresponding of the master device corresponding to the device identifier to the master device corresponding to the smart device; wherein the user contact information of each master device includes contact information of the user of the master device and contact information of the users of the smart devices having control relation with the master device.

Further, in an embodiment of the present disclosure, the control processing unit 220 in the server 200 shown in FIG. 2 is further configured to receive a communication request message sent by a smart device, communication data, the device identifier of the smart device and the device identifier of the smart device of a specified friend being included in the communication request message; according to the device identifier of the smart device, obtain the device identifier of the master device corresponding to the smart device from the control relation database; according to the device identifier of the smart device of the specified friend, obtain the device identifier of the master device corresponding to the smart device of the specified friend from the control relation database; according the obtained device identifiers, transmit the communication request message to the smart device of the specified friend, the master device corresponding to the smart device, and the master device corresponding to the smart device of the specified friend respectively.

Further, in an embodiment of the present disclosure, the control processing unit 220 in the server 200 shown in FIG. 2 is further configured to receive a communication request message sent by a master device, communication data, the device identifier of the master device and the device identifier of the master device specified in a friend list being included in the communication request message; according to the device identifier of the specified master device, transmit the communication data and the device identifier of the master device to the specified master device.

Further, in an embodiment of the present disclosure, the control processing unit 220 in the server 200 shown in FIG. 2 is further configured to, when device identifiers of multiple smart devices are bounded to each other, establish a smart device group, wherein there is a friend relation between any two smart devices in a relation of the group; according to the device identifier of each smart device, obtain the device identifier of the master device corresponding to the smart device from the control relation database; and bind the device identifiers of the multiple master devices corresponding to the multiple smart devices to each other and establish a master device group corresponding to the smart device group.

Further, in an embodiment of the present disclosure, the control processing unit 220 in the server 200 shown in FIG. 2 is further configured to receive a communication request message transmitted into the smart device group by any smart device in the smart device group, the communication data and the device identifier of the smart device being included in the communication request message; transmit the communication request message to other respective smart devices in the smart device group, and transmit the communication request message to respective master devices in the master device group corresponding to the smart device group.

Further, in an embodiment of the present disclosure, the control processing unit 220 in the server 200 shown in FIG. 2 is further configured to receive a communication request message transmitted into the master device group by any master device in the master device group, the communication data and the device identifier of the master device being included in the communication request message; and transmit the communication request message to respective master devices in the master device group.

It should be noted that, respective embodiments of the server shown in FIG. 2 are correspondingly the same as the respective embodiments of the method shown in FIG. 1, which have been explained in detail above and will not repeated here.

In summary, the technical solution provided by the present disclosure on the one hand obtains and stores corresponding control relations between the master device and the smart device through authentication and on the other hand stores association relations between smart device, and in accordance with the association relation between the smart device and the smart device, establishes an association relation between the corresponding master devices. In accordance with this solution, for a user who has requirements for management, a corresponding master device is provided for the smart device of the user, and the association information of the corresponding master device with other master devices is established in accordance with the association information of the smart device with other smart devices, such that the control of the smart device by the master device is no longer limited to a one-on-one individual control, but rather the master device monitor and control of interaction of the corresponding smart devices in their association information by means of the association information between the master devices, and a more realistic status about the corresponding smart device is obtained from others and a more comprehensive and effective management of the correspond smart device by the master devices is achieved.

It should be noted that:

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the server for implementing the control of the smart devices by the master devices according to the embodiments in the disclosure in practice. The disclosure can also realize one part of or all devices or system programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

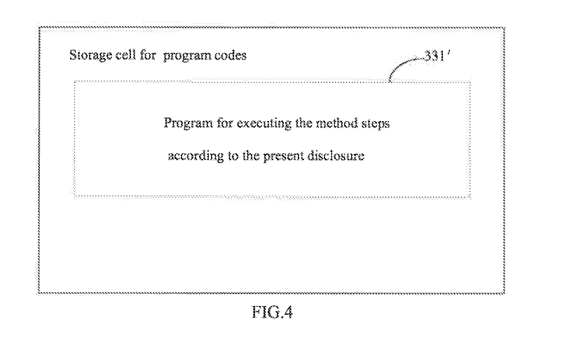

For example, FIG. 3 shows a block diagram for a server for executing the method according to the present disclosure. The server traditionally comprises a processor 310 and a computer program product in the form of storage 320 or a computer readable medium. The storage 320 can be electronic storage such as flash memory, EEPROM (Electrically Erasable Programmable Read-Only Memory), EPROM, hard disk or ROM, and the like. The storage 320 possesses storage space 330 for carrying out procedure code 331 of any method steps of afore the method. For example, storage space 330 for procedure code can comprise various procedure codes 331 used for realizing any steps of afore the method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as described referring to FIG. 4. The storage cell can possess memory segments, storage space like the storage 320 in the server in FIG. 3. The procedure code can be compressed in, for example, a proper form. Generally, storage cell comprises computer readable code 331′, i.e. the code can be read by processors such as 310 and the like. When the codes run on the server, the server will carry out various steps of the method described above.

The “an embodiment”, “embodiments” or “one or more embodiments” referred here mean being included in at least one embodiment in the disclosure combining specific features, structures or characteristics described in the embodiments. In addition, please note that the phrase “in an embodiment” not necessarily mean a same embodiment.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

What is claimed is:

1. A method for implementing control of smart devices by master devices, wherein the method comprises:
receiving control authority authentication information on a corresponding smart device transmitted by a master device and after successfully authentication, storing correspondingly a device identifier of the master device and a device identifier of the corresponding smart device into a control relation database;
for a smart device,
according to the device identifier of the smart device, obtaining the device identifier of the master device corresponding to the smart device from the control relation database, and obtaining first association information of the smart device from a first association database, the first association information including a device identifier of an associated smart device;
according to the device identifier of each associated smart device, obtaining the device identifier of the master device corresponding to the associated smart device from the control relation database; storing correspondingly the device identifier of the master device corresponding to the associated smart device and the device identifier of the master device corresponding to the smart device into a second association database, and establishing an association relation between the master device corresponding to the associated smart device and the master device corresponding to the smart device.

2. The method according to claim 1, wherein
the first association database includes a first friend list database in which friend relation between the smart devices is stored; the first association information of the smart device includes pieces of friend information in the friend list of the smart device; the device identifier of the each associated smart device includes the device identifier of the smart device of a friend corresponding to each piece of friend information;
the second association database includes a second friend list database in which friend relation between the master devices is stored;
establishing the association relations between the master devices corresponding to the associated smart devices and the master device corresponding to the smart device includes:
establishing friend relation between the master device corresponding to the smart device of the friend and the master device corresponding to the smart device.

3. The method according to claim 2, wherein the establishing the friend relation between the master device corresponding to the smart device of the friend and the master device corresponding to the smart device comprises:
according to the device identifier of the master device corresponding to the smart device, obtaining user contact information of the master device from a contact information database and obtaining the friend list of the master device from the second friend list database;
according to each device identifier in the friend list, obtaining the user contact information corresponding to the device identifier from the contact information database; transmitting the user contact information of the master device corresponding to the smart device to the master device corresponding to the device identifier and transmitting the user contact information of the master device corresponding to the device identifier to the master device corresponding to the smart device;
wherein the user contact information of each master device includes contact information of the user of the master device and contact information of the users of the smart devices having control relation with the master device.

4. The method according to claim 2, wherein the method further comprises:
receiving a communication request message sent by a smart device, communication data, the device identifier of the smart device and the device identifier of the smart device of a specified friend being included in the communication request message;
according to the device identifier of the smart device, obtaining the device identifier of the master device corresponding to the smart device from the control relation database; according to the device identifier of the smart device of the specified friend, obtaining the device identifier of the master device corresponding to the smart device of the specified friend from the control relation database;
according the obtained device identifiers, transmitting the communication request message to the smart device of the specified friend, the master device corresponding to the smart device and the master device corresponding to the smart device of the specified friend respectively.

5. The method according to claim 2, wherein the method further comprises:
receiving a communication request message sent by a master device, communication data, the device identifier of the master device and the device identifier of the master device specified in a friend list being included in the communication request message;
according to the device identifier of the specified master device, transmitting the communication data and the device identifier of the master device to the specified master device.

6. The method according to claim 2, wherein the method further comprises:
when device identifiers of multiple smart devices are bounded to each other, establishing a smart device group, wherein there is a friend relation between any two smart devices in a relation of the group;
according to the device identifier of each smart device, obtaining the device identifier of the master device corresponding to the smart device from the control relation database;
binding the device identifiers of the multiple master devices corresponding to the multiple smart devices to each other and establishing a master device group corresponding to the smart device group.

7. The method according to claim 6, wherein the method further comprises:
receiving a communication request message transmitted into the smart device group by any smart device in the smart device group, communication data and the device identifier of the smart device being included in the communication request message;
transmitting the communication request message to other respective smart devices in the smart device group, and transmitting the communication request message to respective master devices in the master device group corresponding to the smart device group.

8. The method according to claim 6, wherein the method further comprises:
receiving a communication request message transmitted into the master device group by any master device in the master device group, communication data and the device identifier of the master device being included in the communication request message;
transmitting the communication request message to respective master devices in the master device group.

9. A server for implementing control of smart devices by master devices, wherein the server comprises:
one or more processors; and
a memory;
wherein one or more programs are stored in the memory, and when executed by the one or more processors, the one or more programs cause the server to:
receive control authority authentication information on a corresponding smart device transmitted by a master device and after successfully authentication, store correspondingly a device identifier of the master device and a device identifier of the corresponding smart device into a control relation database;
for a smart device:
according to device identifier of the smart device, obtain device identifier of the master device corresponding to the smart device from the control relation database, and obtain first association information of the smart device from a first association database, the first association information including the device identifier of an associated smart device;
according to the device identifier of each associated smart device, obtain the device identifier of the master device corresponding to the associated smart device from the control relation database; store correspondingly the device identifier of the master device corresponding to the associated smart device and the device identifier of the master device corresponding to the smart device into a second association database, and establish an association relation between the master device corresponding to the associated smart device and the master device corresponding to the smart device.

10. The server according to claim 9, wherein
the first association database includes a first friend list database in which friend relation between the smart devices is stored; the first association information of the smart device includes pieces of friend information in the friend list of the smart device;
the device identifier of the each associated smart device includes the device identifier of the smart device of a friend corresponding to each piece of friend information;
the second association database includes a second friend list database in which friend relation between the master devices is stored;
the server are further caused to: establish friend relation between the master device corresponding to the smart device of the friend and the master device corresponding to the smart device.

11. The server according to claim 10, wherein the server are further caused to:
according to the device identifier of the master device corresponding to the smart device, obtain user contact information of the master device from a contact information database and obtain the friend list of the master device from the second friend list database;
according to each device identifier in the friend list, obtain the user contact information corresponding to the device identifier from the contact information database; transmit the user contact information of the master device corresponding to the smart device to the master device corresponding to the device identifier and transmit the user contact information corresponding of the master device corresponding to the device identifier to the master device corresponding to the smart device;
wherein the user contact information of each master device includes contact information of the user of the master device and contact information of the users of the smart devices having control relation with the master device.

12. The server according to claim 10, wherein the server are further caused to:
receive a communication request message sent by a smart device, communication data, the device identifier of the smart device and the device identifier of the smart device of a specified friend being included in the communication request message;
according to the device identifier of the smart device, obtain the device identifier of the master device corresponding to the smart device from the control relation database; according to the device identifier of the smart device of the specified friend, obtain the device identifier of the master device corresponding to the smart device of the specified friend from the control relation database; according the obtained device identifiers, and transmit the communication request message to the smart device of the specified friend, the master device corresponding to the smart device, and the master device corresponding to the smart device of the specified friend, respectively.

13. The server according to claim 10, wherein the server are further caused to:
receive a communication request message sent by a master device, communication data, the device identifier of the master device and the device identifier of the master device specified in a friend list being included in the communication request message;
according to the device identifier of the specified master device, transmit the communication data and the device identifier of the master device to the specified master device.

14. The server according to claim 10, wherein the server are further caused to:
when device identifiers of multiple smart devices are bounded to each other, establish a smart device group, wherein there is a friend relation between any two smart devices in a relation of the group;
according to the device identifier of each smart device, obtain the device identifier of the master device corresponding to the smart device from the control relation database;
and bind the device identifiers of the multiple master devices corresponding to the multiple smart devices to each other and establish a master device group corresponding to the smart device group.

15. The server according to claim 14, wherein the server are further caused to:
receive a communication request message transmitted into the smart device group by any smart device in the smart device group, the communication data and the device identifier of the smart device being included in the communication request message;
transmit the communication request message to other respective smart devices in the smart device group, and transmit the communication request message to respective master devices in the master device group corresponding to the smart device group.

16. The server according to claim 14, wherein the server are further caused to:
receive a communication request message transmitted into the master device group by any master device in the master device group, the communication data and the device identifier of the master device being included in the communication request message;
and transmit the communication request message to respective master devices in the master device group.

17. (canceled)

18. (canceled)

19. A non-transitory computer readable medium having computer programs stored thereon that, when executed by one or more processors of a computing device, cause the computing device to perform operations for implementing control of smart devices by master devices, the operations comprising:
receiving control authority authentication information on a corresponding smart device transmitted by a master device and after successfully authentication, storing correspondingly a device identifier of the master device and a device identifier of the corresponding smart device into a control relation database;
for a smart device,
according to the device identifier of the smart device, obtaining the device identifier of the master device corresponding to the smart device from the control relation database, and obtaining first association information of the smart device from a first association database, the first association information including a device identifier of an associated smart device;
according to the device identifier of each associated smart device, obtaining the device identifier of the master device corresponding to the associated smart device from the control relation database; storing correspondingly the device identifier of the master device corresponding to the associated smart device and the device identifier of the master device corresponding to the smart device into a second association database, and establishing an association relation between the master device corresponding to the associated smart device and the master device corresponding to the smart device.
